(19) United States
(12) Patent Application Publication
(10) Pub. No.: US 2026/0368643 A1
(43) Pub. Date: Nov. 19, 2026

(54) Clustering Multi-Vector Embeddings for Denoising and Pruning

(71) Applicant: GDM Holding LLC, Mountain View, CA (US)

(72) Inventors: João Mateus de Freitas Veneroso, Belo Horizonte (BR); Daniel Matthew Cer, Santa Clara, CA (US); Gustavo Adolfo Hernandez Abrego, Los Altos, CA (US); Jinmeng Rao, Sunnyvale, CA (US); Majid Hadian, San Jose, CA (US); Rajesh Jayaram, New York, NY (US)

(21) Appl. No.: 19/675,344

(22) Filed: May 12, 2026

Related U.S. Application Data
(60) Provisional application No. 63/804,872, filed on May 13, 2025.

(51) Int. Cl. G06N 20/00; G06F 18/22; G06F 18/231; G06F 18/23211

(52) U.S. Cl. CPC G06N 20/00; G06F 18/22; G06F 18/231; G06F 18/23211

(57) ABSTRACT

Systems can generate multi-vector embeddings of content items, reduce the number of vectors by clustering them, and then using the resulting compressed representations for retrieval tasks. For example, a machine-learned multi-vector embedding model can process a content item to create multiple vectors that each represent a portion (e.g., a token) of the item. The system can then cluster these vectors into a smaller set for more compact storage in a retrieval index. Additionally, the system can compute similarity scores (e.g., Chamfer distance) between the compressed embedding sets and embedding(s) associated with an input content item (which may themselves be optionally compressed as described herein). The computing system can select (e.g., rank) candidate items that best align with the input content item based on the computed similarity scores. This approach can be beneficial for deployment in scenarios like large-scale web search, image or audio search, retrieval-augmented generation, and/or other applications.

### RELATED APPLICATIONS

This application claims priority to and the benefit of U.S. Provisional Patent Application No. 63/804,872, filed May 13, 2025, and titled “CLUSTERING MULTI-VECTOR EMBEDDING FOR DENOISING AND PRUNING”. U.S. Provisional Patent Application No. 63/804,872 is hereby incorporated by reference in its entirety.

### FIELD

The present disclosure relates generally to machine learning processes and machine-learned devices and systems. More particularly, the present disclosure relates to clustering multi-vector embeddings for denoising and pruning.

### BACKGROUND

Certain modern information retrieval techniques rely on numerical representations expressed within a latent space—also known as embeddings—to process and compare text content, image content, audio content, and/or other forms of content items. One particular type of embedding that can be generated for a particular content item is a multi-vector embedding, in which multiple vectors are generated for the content item. For example, the multiple vectors for the content item can correspond to different portions of the content item, such as tokens, sentences, paragraphs, pages, image frames, temporal windows, delimited sections, segments, chunks, or other portions of the content item.

However, these multi-vector embeddings can consume extensive system resources when stored and/or analyzed, particularly for large or complex content items (e.g., documents spanning many pages, video files with large numbers of image frames, etc.). This resource consumption can impede the scalability of a retrieval system by leading to higher memory footprints, longer processing times, and increased latency during tasks like searching and/or re-ranking. Furthermore, when data is noisy or combines multiple topic areas in a single document and/or query, the large number of embedding vectors can introduce extraneous signals that degrade retrieval accuracy.

Collectively, these issues present a technical problem in balancing precision and recall with latency and storage constraints in multi-vector retrieval scenarios, particularly for web-scale or enterprise-scale deployments.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method for information retrieval with improved computational efficiency. The computer-implemented method includes obtaining, by a computing system may include one or more computing devices, an input content item may include a plurality of portions; processing, by the computing system, the input content item with a machine-learned multi-vector embedding model to generate a plurality of portion embedding vectors that respectively correspond to the plurality of portions of the input content item; clustering, by the computing system, the plurality of portion embedding vectors to generate a plurality of input content embedding vectors, the plurality of input content embedding vectors may include a smaller number of vectors relative to the plurality of portion embedding vectors; accessing, by the computing system, multiple pluralities of candidate content embedding vectors respectively associated with a plurality of candidate content items; determining, by the computing system, a respective similarity score between the plurality of input content embedding vectors and each plurality of candidate content embedding vectors; and selecting, by the computing system, one or more of the plurality of candidate content items as selected content items based on the respective similarity score between the plurality of input content embedding vectors and each plurality of candidate content embedding vectors. Other embodiments of this aspect include corresponding computer systems, apparatus, and computer programs recorded on one or more computer storage devices, each configured to perform the actions of the methods.

Implementations may include one or more of the following features. The computer-implemented method may include: generating the multiple pluralities of candidate content embedding vectors, where generating the plurality of candidate content embedding vectors for each candidate content item may include: processing, by the computing system, the candidate content item with the machine-learned multi-vector embedding model or a second, different machine-learned multi-vector embedding model to generate a plurality of intermediate embedding vectors; and clustering, by the computing system, the plurality of intermediate embedding vectors to obtain the plurality of candidate content embedding vectors for the candidate content item, where the plurality of candidate content embedding vectors for the candidate content item may include a smaller number of vectors relative to the plurality of intermediate embedding vectors for the candidate content item. Generating the multiple pluralities of candidate content embedding vectors may be performed offline and the multiple pluralities of candidate content embedding vectors are stored in and accessed from a non-tangible computer-readable memory. The plurality of portions of the input content item may include a plurality of tokens of the input content item. Clustering, by the computing system, the plurality of portion embedding vectors to generate the plurality of input content embedding vectors may include: clustering, by the computing system, the plurality of portion embedding vectors to form a plurality of clusters; and respectively pooling, by the computing system, the portion embedding vectors contained in each cluster to generate the plurality of input content embedding vectors. Clustering, by the computing system, the plurality of portion embedding vectors may include performing, by the computing system, k-means clustering on the plurality of portion embedding vectors to generate a number k of input content embedding vectors. The number k can be predefined. Clustering, by the computing system, the plurality of portion embedding vectors may include performing, by the computing system, a hierarchical clustering algorithm on the input content item to generate a hierarchically-structured set of input content embedding vectors. Determining, by the computing system, the respective similarity score between the plurality of input content embedding vectors and each plurality of candidate content embedding vectors may include determining, by the computing system, a respective Chamfer distance between the plurality of input content embedding vectors and each plurality of candidate content embedding vectors. The input content item may include a search query and the plurality of candidate content items may include a plurality of indexed web documents. The computer-implemented method may include: returning, by the computing system, the selected content items as results for display to a user. The computer-implemented may include training, by the computing system, the machine-learned multi-vector embedding model based at least in part on the input content embedding vectors. A computing system configured to perform the method of claim 1. The input content item may include an image search query and the plurality of candidate content items may include a plurality of candidate image search results. The input content item may include an audio search query and the plurality of candidate content items may include a plurality of candidate audio search results. The input content item may include at least a portion of a model input to a machine learning model and the plurality of candidate content items may include content items associated with a retrieval augmented generation system. The computer-implemented method may include: generating, by the computing system, an updated model input that includes the selected content items; and processing, by the computing system, the updated model input with the machine learning model to generate a model output. Determining, by the computing system, the respective similarity score between the plurality of input content embedding vectors and each plurality of candidate content embedding vectors may include respectively processing, by the computing system, each unique combination of the plurality of input content embedding vectors and the multiple pluralities of candidate content embedding vectors with one or more linear or non-linear layers to generate the respective similarity score for such unique combination. The number k can be adaptive to and a function of a length of the input content item. The plurality of portions of the input content item may include a plurality of sentences, a plurality of paragraphs, a plurality of pages, or a plurality of delimited sections of the input content item. Implementations of the described techniques may include hardware, a method or process, or computer software on a computer-accessible medium.

Another general aspect includes a computer-implemented method for information retrieval with improved computational efficiency. The computer-implemented method includes obtaining, by a computing system may include one or more computing devices, a plurality of candidate content items, each candidate content item may include a plurality of portions; generating, by the computing system, multiple pluralities of candidate content embedding vectors respectively for the plurality of candidate content items, where generating the plurality of candidate content embedding vectors for each candidate content item may include: processing, by the computing system, the candidate content item with a machine-learned multi-vector embedding model to generate a plurality of intermediate embedding vectors that respectively correspond to the plurality of portions of the candidate content item; and clustering, by the computing system, the plurality of intermediate embedding vectors to obtain the plurality of candidate content embedding vectors for the candidate content item, where the plurality of candidate content embedding vectors for the candidate content item may include a smaller number of vectors relative to the plurality of intermediate embedding vectors for the candidate content item. The method also includes storing, by the computing system, the multiple pluralities of candidate content embedding vectors in a retrieval index. Other embodiments of this aspect include corresponding computer systems, apparatus, and computer programs recorded on one or more computer storage devices, each configured to perform the actions of the methods.

Implementations may include one or more of the following features. The computer-implemented method may include: obtaining, by a computing system may include one or more computing devices, an input content item; processing, by the computing system, the input content item with the machine-learned multi-vector embedding model or a second, different machine-learned multi-vector embedding model to generate a plurality of input content embedding vectors; determining, by the computing system, a respective similarity score between the plurality of input content embedding vectors and each plurality of candidate content embedding vectors; and selecting, by the computing system, one or more of the plurality of candidate content items as selected content items based on the respective similarity score between the plurality of input content embedding vectors and each plurality of candidate content embedding vectors. Determining, by the computing system, the respective similarity score between the plurality of input content embedding vectors and each plurality of candidate content embedding vectors may include determining, by the computing system, a respective chamfer distance between the plurality of input content embedding vectors and each plurality of candidate content embedding vectors. Clustering, by the computing system, the plurality of intermediate embedding vectors to generate the plurality of candidate content embedding vectors may include: clustering, by the computing system, the plurality of intermediate embedding vectors to form a plurality of clusters; and respectively pooling, by the computing system, the intermediate embedding vectors contained in each cluster to generate the plurality of candidate content embedding vectors. Clustering, by the computing system, the plurality of intermediate embedding vectors may include performing, by the computing system, k-means clustering on the plurality of intermediate embedding vectors to generate a number k of candidate content embedding vectors. Clustering, by the computing system, the plurality of intermediate embedding vectors may include performing, by the computing system, a hierarchical clustering algorithm on each candidate content item to generate a hierarchically-structured set of candidate content embedding vectors. The input content item may include a search query and the plurality of candidate content items may include a plurality of indexed web documents. The input content item may include an image search query and the plurality of candidate content items may include a plurality of candidate image search results. The input content item may include an audio search query and the plurality of candidate content items may include a plurality of candidate audio search results. The computer-implemented method may include: returning, by the computing system, the selected content items as results for display to a user. The input content item may include at least a portion of a model input to a machine learning model and the plurality of candidate content items may include content items associated with a retrieval augmented generation system. The plurality of portions of each candidate content item may include a plurality of tokens of each candidate content item. The plurality of portions of each candidate content item may include a plurality of sentences, a plurality of paragraphs, a plurality of pages, or a plurality of delimited sections of each candidate content item. The computer-implemented method may include performing, by the computing system, training of the machine-learned multi-vector embedding model based at least in part on the multiple pluralities of candidate content embedding vectors. Determining, by the computing system, the respective similarity score between the plurality of input content embedding vectors and each plurality of candidate content embedding vectors may include respectively processing, by the computing system, each unique combination of the plurality of input content embedding vectors and the multiple pluralities of candidate content embedding vectors with one or more linear or non-linear layers to generate the respective similarity score for such unique combination. Implementations of the described techniques may include hardware, a method or process, or computer software on a computer-accessible medium.

### BRIEF DESCRIPTION OF THE DRAWINGS

FIG. 1 is a block diagram illustrating an example system architecture for embedding and clustering according to example implementations of aspects of the present disclosure;

FIG. 2 is a block diagram illustrating an example training framework with multi-vector clustering according to example implementations of aspects of the present disclosure;

FIG. 3 is a flowchart diagram illustrating an example method for embedding vector generation and storage according to example implementations of aspects of the present disclosure;

FIG. 4 is a flowchart diagram illustrating an example method for content retrieval based on similarity scoring according to example implementations of aspects of the present disclosure;

FIG. 5 is a flow chart diagram illustrating an example method for training a machine-learned model according to example implementations of aspects of the present disclosure;

FIG. 6 is a block diagram of an example processing flow for using machine-learned model(s) to process input(s) to generate output(s) according to example implementations of aspects of the present disclosure;

FIG. 7 is a block diagram of an example sequence processing model according to example implementations of aspects of the present disclosure;

FIG. 8 is a block diagram of an example technique for populating an example input sequence for processing by a sequence processing model according to example implementations of aspects of the present disclosure;

FIG. 9 is a block diagram of an example model development platform according to example implementations of aspects of the present disclosure;

FIG. 10 is a block diagram of an example training workflow for training a machine-learned model according to example implementations of aspects of the present disclosure;

FIG. 11 is a block diagram of an inference system for operating one or more machine-learned model(s) to perform inference according to example implementations of aspects of the present disclosure;

FIG. 12 is a block diagram of an example networked computing system according to example implementations of aspects of the present disclosure;

FIG. 13 is a block diagram of an example computing device according to example implementations of aspects of the present disclosure; and

FIG. 14 is a block diagram of an example computing device according to example implementations of aspects of the present disclosure.

### DETAILED DESCRIPTION

Example aspects of the present disclosure are directed to systems and methods for clustering multi-vector representations for denoising and pruning. In particular, example systems described herein can generate multi-vector embeddings of content items, reduce the number of vectors by clustering them, and then using the resulting compressed representations for retrieval tasks. For example, a machine-learned multi-vector embedding model can process a content item to create multiple vectors that each represent a portion (e.g., a token) of the item. The system can then cluster these vectors into a smaller set for more compact storage in a retrieval index. Additionally, the system can compute similarity scores (e.g., Chamfer distance) between the compressed embedding sets and embedding(s) associated with an input content item (which may themselves be optionally compressed as described herein). The computing system can select (e.g., rank) candidate items that best align with the input content item based on the computed similarity scores. This approach can be beneficial for deployment in scenarios like large-scale web search, image or audio search, retrieval-augmented generation, and/or other applications.

Example technical problems addressed by the present disclosure include the large storage requirements and susceptibility to noise in multi-vector embedding models. In particular, prior techniques that rely on many vectors to represent long queries and/or long content can consume substantial memory, which can limit overall scalability and efficiency. These techniques can also degrade in performance when faced with noisy or adversarial input, for instance when queries include irrelevant or overly long concatenated tokens.

As a technical solution to the above challenges, the present disclosure provides a clustering-based pruning approach that can reduce the number of embedding vectors while seeking to preserve relevant information. For example, example systems described herein can process a content item (e.g., a content item to be indexed and/or a content item that serves as a query) using a machine-learned embedding model to generate multiple embedding vectors that correspond to portions of the content item. In some implementations, the system can cluster these embedding vectors using a clustering algorithm (e.g., K-means clustering, hierarchical clustering, and/or other clustering techniques). The system can then combine (e.g., pool, average, etc.) the vectors within each cluster to form a smaller set of representative vectors. This smaller set can allow storage of fewer vectors and can lessen redundant or noisy signals.

The generated compressed representations can be beneficial for retrieval tasks, retrieval-augmented generation, and/or other embedding-based operations. For instance, such representations can be stored in a retrieval index and compared against a set of compressed vectors associated with an input content item. For example, the comparisons can be performed using similarity measures like Chamfer distance, projection layer(s), or other similarity measures. In some implementations, in addition to improving resource consumption by storing fewer vectors per content item, the proposed approach can also provide more consistent results when matching a query against long or noisy content. Specifically, the clustering operations can naturally operate to denoise the content.

According to another aspect of the present disclosure, in some implementations, the proposed clustering approach can be integrated directly into model training rather than applying it strictly as a post-processing step. For example, the system can perform the clustering algorithm during each training iteration, generating and updating cluster assignments in parallel with the model's embedding layers. Performing clustering during training can lead to superior performance compared to clustering only after training has completed. By updating cluster parameters in tandem with the underlying embedding model, the network can adapt its parameters in a way that more closely aligns with the clustered representations, which can thereafter result in improved retrieval effectiveness.

More particularly, a computing system (e.g., an indexing component of the computing system) can obtain multiple candidate content items, such as multiple textual documents, web documents, images, videos, audio content, multi-modal content, etc. Each candidate content item can include a plurality of portions (e.g., tokens, paragraphs, sentences, pages, image frames, or other structured or delimited sections). The computing system can process each content item with a machine-learned multi-vector embedding model. For each content item, the machine-learned multi-vector embedding model can generate a set of intermediate embedding vectors corresponding to the plurality of portions (e.g., one intermediate vector per portion). The computing system can then apply a clustering algorithm to reduce these intermediate vectors into a smaller collection of candidate content embedding vectors, thus representing each candidate content item in a more compact form.

In some implementations, the system can then store these reduced representations in a retrieval index, which can make matching and retrieval more efficient for subsequent queries. The retrieval index can reside in memory or on another suitable storage medium. For example, the system can allocate an index data structure where each candidate item's compact embedding representation is recorded (e.g., alongside its associated metadata). This indexing arrangement can enable efficient lookups or comparisons by downstream retrieval processes, such as when matching new queries against previously indexed content.

In particular, either contemporaneous with the operations described above or potentially at a later time, the computing system (e.g., a retrieval component of the system) can obtain an input content item. The input content item can be a textual query, an image query, an audio query, a multi-modal query, and/or other forms of content. The computing system can generate a set of input content embedding vectors using either the same multi-vector embedding model as mentioned above or a second, different embedding model (e.g., which may have been trained jointly with the first model). As one example, the system can generate a plurality of portion embedding vectors respectively corresponding to a plurality of portions of the input content item. The system can cluster the plurality of portion embedding vectors as described above to generate the reduced set of input content embedding vectors.

The system can then compute respective similarity scores between the generated input content embedding vectors and each set of candidate content embedding vectors for each candidate content item. The system can select one or more candidate content items based on these similarity scores, such as selecting candidates with higher similarity, thereby matching the input content item to potentially relevant results. As described in further detail below, these selected items can be returned as results (e.g., search results) and/or can be used as additional context (e.g., “exemplars”) for downstream component(s) (e.g., downstream machine learning models such as large language models, vision-language models, or similar).

The similarity comparisons described herein can be performed using a number of different techniques. As one example, in some implementations, the system can perform the similarity comparison by computing a Chamfer distance between the set of input content embedding vectors and each set of candidate content embedding vectors. For example, such a process can involve measuring the distance from each input vector to its nearest candidate vector in the set, then aggregating these values into a final score.

As another example, additionally or alternatively to Chamfer distance, the system can process each combination of input vectors and candidate vectors with one or more linear or non-linear layers (e.g., “projection layer(s)”) to generate similarity scores. For instance, the system can feed a pair of vectors through a neural network layer that outputs a single value, then combine these outputs to produce the overall similarity score. Alternatively, all vectors can be provided as input to the layer(s) to produce a single output score. Other similarity techniques can be used as well, such as Euclidean distance, etc.

The clustering of vectors described herein can be performed using a number of different techniques. As one example, the system can apply a suitable clustering algorithm to group related vectors, and then perform an aggregation operation, such as pooling, averaging, and/or other combination techniques, to produce a single representative vector per cluster. This approach can reduce the dimensionality of the multiple vectors representing the input content item and/or each candidate content item while maintaining the information captured by the original set of vectors.

Thus, in some examples, the computing system can cluster a collection of embedding vectors into multiple groups and then pool the vectors within each group to generate a set of representative embedding vectors. This approach can be performed when clustering vectors for the input content item and/or for the candidate content items.

In some implementations, the computing system can perform K-means clustering on the embedding vectors to generate the reduced set of embedding vectors. For example, in some implementations, the system can specify a predefined value of K to consistently create the same number of clusters/vectors for each content item. In other implementations, K can be adaptive and depend on a dimension such as the length of each content item, allowing the system to tailor the number of clusters to the characteristics of the input data. As one specific, non-limiting example, for each content item, K can equal a value that is one half of the total number of vectors associated with the content item. This adaptive approach can offer flexibility in controlling the trade-off between representation compactness and content fidelity.

As another example, in some implementations, the computing system can apply a hierarchical clustering algorithm to generate a nested or multi-level organization of the embedding vectors for each content item. For example, the system can iteratively merge or split clusters, creating multiple levels of granularity. This process can produce a hierarchically-structured set of embedding vectors, enabling a representation that can be selectively leveraged at different resolutions, such as higher-level clusters for broader groupings and lower-level clusters for more fine-grained distinctions.

As one example, a subset of the hierarchically-structured set of embedding vectors (e.g., one particular layer of the hierarchy) can be selected and used when performing similarity comparison. Generating such a hierarchically-structured set of embedding vectors which can be selectively subsampled provides optionality for retrieval speed/accuracy tradeoff.

In some implementations, the process of generating the candidate content embedding vectors for the candidate content items can be carried out offline, storing the resulting vectors in a non-tangible computer-readable memory. For example, the system can execute a batch pipeline that processes each candidate content item independently, aggregates its intermediate embedding vectors, and converts them into a smaller set of candidate content embedding vectors before saving these sets in a dedicated storage resource. This offline procedure can allow for more efficient memory usage and improved speed at query time, since the candidate content embedding vectors have already been computed and can be directly retrieved when needed.

The proposed techniques can be used in a number of different applications or use cases.

As one example application, the input content item can be a search query. The system can match the search query against a set of indexed web documents. For example, the process can involve generating embedding vectors for the query, comparing them to precomputed embeddings of various web pages, and returning any documents that show a higher level of semantic similarity to the query's content.

As another example application, the approach can also be applied to image-based queries, enabling the system to work with candidate image search results. For instance, the system can produce vector representations of image features, then compute similarity scores between those representations and an input query that itself can be represented textually or image-based, depending on the use case.

As another example application, the system can be applied to audio queries by generating and comparing embedding vectors that capture audio features. This capability can make it possible to retrieve candidate audio samples or recordings that align more closely with a given input audio file or audio-based query.

In some implementations, the system can provide the selected content items to a user interface for display or further presentation. For example, a web-based interface can be updated to show the top results based on the most relevant embeddings. This can allow end users to view or interact directly with the most relevant documents, images, or other multimedia based on their query.

As another example application, the input content item can be part of a larger pipeline for retrieval augmented generation (RAG). For instance, the embedding vectors can be used to identify which pieces of content in a retrieval store are most aligned with the query, providing relevant supplementary information to a language or multimodal model.

In particular, in some implementations, the system (e.g., a RAG component of the system) can create an updated model input by appending or merging the selected content items with the original query. The computing system can then process this updated model input through a machine learning model. For example, the system can run a sequence processing model on the combined text to produce an enhanced output, such as a more informative answer or an augmented summary that incorporates details from the retrieved content.

Furthermore, in some implementations, the system can train the machine-learned multi-vector embedding model by leveraging the embedding vectors built from both input content items and candidate content items. For example, the system can feed these vectors into a training pipeline that updates the model's weights and/or the embeddings themselves to better align with relevance or similarity objectives defined by a specific application. This can involve obtaining or generating data that indicates whether certain items should be deemed more similar or dissimilar and adjusting the model accordingly.

In some implementations, the training process can include backpropagation steps that measure discrepancies between an expected outcome and the model's current outputs. For instance, the system can compare predicted similarities with ground truth judgments or known pairwise labels, then refine the model's parameters based on these differences. This ongoing training cycle can help the model learn a robust representation of the content items, which can be beneficial for downstream tasks like ranking or recommendation.

The systems and methods of the present disclosure provide a number of technical effects and benefits.

One example technical effect is improved resource usage within a computer system. By clustering and pruning multi-vector embeddings, the method uses fewer embedding vectors to represent a content item such as a query or document. Using fewer embedding vectors reduces the amount of data that needs to be stored, retrieved, and processed. This reduction in memory and storage consumption can directly impact how a computing system manages resources, resulting in an efficiency gain that is rooted in the way hardware and software interact.

A further technical advantage relates to the system's ability to handle complex or noisy data inputs with improved performance. Instead of storing and comparing every token-level or fragment-level embedding, the proposed clustering produces compressed representations that preserve salient information while removing redundancy. As a result, the approach can complete similarities or distance computations with fewer operations, which corresponds to an improvement to the speed and reliability of data processing in a computer environment.

Additionally, the approach can easily be integrated into existing retrieval pipelines, leading to a measurable improvement in real-time or near-real-time response scenarios such as search or retrieval-augmented generation. By leveraging the compressed embeddings during comparison, the implemented system can serve requests faster and process higher query volumes without incurring new hardware requirements. This synergy of data processing and resource utilization directly addresses hardware constraints in modern computing infrastructures.

Various example implementations are described herein with respect to the accompanying Figures.

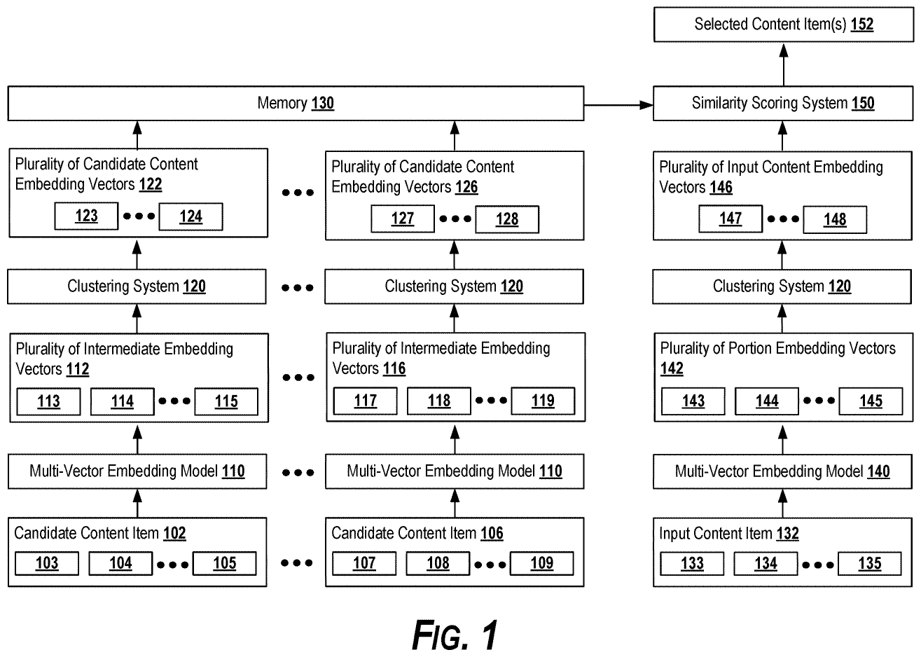

FIG. 1 illustrates an example system architecture in which multi-vector embedding representations can be generated, clustered, and stored for both candidate content items and an input content item. As one example, a multi-vector embedding model can produce intermediate embedding vectors, which can then be clustered into fewer representative vectors by a clustering system. These clustered candidate embeddings can be stored in memory and compared, via a similarity scoring system, to clustered input embeddings for purposes such as identifying selected content items.

Now referring to FIG. 1 in more detail, candidate content item 102 can include various types of content such as text documents, images, and/or audio files, which are divided into multiple portions 103, 104, 105. Each portion can represent a different segment of the candidate content item 102, such as tokens or paragraphs in a text document or frames in a video.

Any number of candidate content items can be processed. For example, a second candidate content item 106 is shown, with portions 107, 108, and 109.

Multi-vector embedding model 110 can process the portions of the candidate content item 102 to generate a plurality of intermediate embedding vectors 112. Each intermediate embedding vector 113, 114, 115 can represent a numerical representation of the respective portions of the candidate content item 102. Similarly, multi-vector embedding model 110 can process the portions of the candidate content item 106 to generate a plurality of intermediate embedding vectors 116. Each intermediate embedding vector 117, 118, 119 can represent a numerical representation of the respective portions of the candidate content item 106.

Clustering system 120 can cluster the plurality of intermediate embedding vectors 112 to form a plurality of candidate content embedding vectors 122. Each candidate content embedding vector 123, 124 can represent a clustered group of intermediate embedding vectors, potentially reducing the dimensionality and focusing on the most relevant features. Similarly, clustering system 120 can cluster the plurality of intermediate embedding vectors 116 to form a plurality of candidate content embedding vectors 126. Each candidate content embedding vector 127, 128 can represent a clustered group of intermediate embedding vectors, potentially reducing the dimensionality and focusing on the most relevant features.

Memory 130 can store the plurality of candidate content embedding vectors 122 and the plurality of candidate content embedding vectors 126, maintaining them for subsequent retrieval and comparison processes.

The system also includes an input content item 132, which similarly can be divided into portions 133, 134, 135. Like the candidate content item 102, the input content item 132 can be processed by the same embedding model or a different multi-vector embedding model 140 (e.g., which may have been jointly trained with model 120) to generate a plurality of portion embedding vectors 142. Each portion embedding vector 143, 144, 145 represents a numerical representation of the respective portions of the input content item 132.

Clustering system 120 can also cluster the plurality of portion embedding vectors 142 to produce a plurality of input content embedding vectors 146. Each input content embedding vector 147, 148 can represent a clustered group of portion embedding vectors.

In some implementations, clustering system 120 could also be different for or perform different operations for the query and candidate embeddings. For example, the clustering system 120 could perform clustering on the query embeddings with k=4 and on the candidate embeddings with k=8. Thus, different clustering systems and/or algorithms can be used for query and candidate as long as the sets of embeddings are compatible with the similarity function.

Similarity scoring system 150 can compare the plurality of input content embedding vectors 146 with the plurality of candidate content embedding vectors 122 stored in memory 130. This comparison can determine, for example, the degree of similarity between the input content item 132 and each candidate content item 102, 106.

Selected content item(s) 152 can be the result of the comparison process, where content items that meet a certain similarity threshold are selected from the candidate content items stored in memory 130.

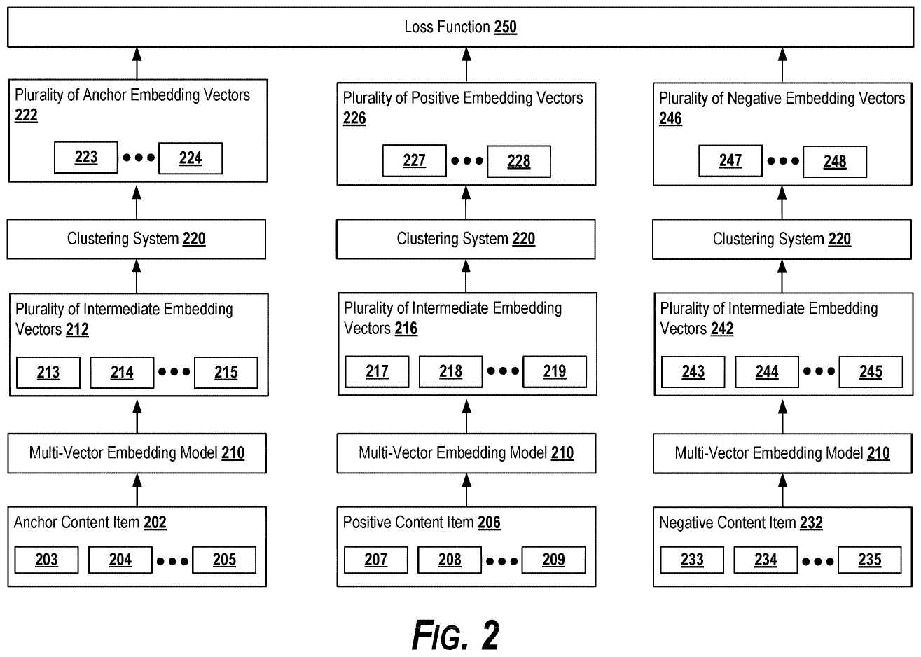

FIG. 2 depicts an example training scenario that includes anchor, positive, and negative content items, each of which can be processed by a multi-vector embedding model to produce intermediate embedding vectors. These vectors can then be clustered to generate anchor embedding vectors, positive embedding vectors, and negative embedding vectors. A loss function can operate on the clustered embeddings to help refine the multi-vector embedding model according to similarity or distance objectives, such as those found in a triplet-based training technique.

Now referring to FIG. 2 in more detail, anchor content item 202 can include various types of content such as text documents, images, or audio files, which are divided into multiple portions 203, 204, 205. Each portion can represent a different segment of the anchor content item 202, such as paragraphs in a text document or frames in a video.

Multi-vector embedding model 210 can process the portions of the anchor content item 202 to generate a plurality of intermediate embedding vectors 212. Each intermediate embedding vector 213, 214, 215 can represent a numerical representation of the respective portions of the anchor content item 202.

Clustering system 220 can cluster the plurality of intermediate embedding vectors 212 to form a plurality of anchor embedding vectors 222. Each anchor embedding vector 223, 224 can represent a clustered group of intermediate embedding vectors, potentially reducing the dimensionality and focusing on the most relevant features.

Positive content item 206, similar to the anchor content item 202, can be divided into portions 207, 208, 209, and processed by the multi-vector embedding model 210 to generate a plurality of intermediate embedding vectors 216. Each intermediate embedding vector 217, 218, 219 can then be clustered by the clustering system 220 to form a plurality of positive embedding vectors 226, where each positive embedding vector 227, 228 represents a clustered group of intermediate embedding vectors.

Negative content item 232 can also be divided into portions 233, 234, 235, and similarly processed by the multi-vector embedding model 210 to generate a plurality of intermediate embedding vectors 242. Each intermediate embedding vector 243, 244, 245 can then be clustered by the clustering system 220 to form a plurality of negative embedding vectors 246, where each negative embedding vector 247, 248 represents a clustered group of intermediate embedding vectors.

Loss function 250 can compare the plurality of anchor embedding vectors 222, the plurality of positive embedding vectors 226, and the plurality of negative embedding vectors 246 to adjust and refine the multi-vector embedding model 210 and/or the embeddings themselves based on one or more training objectives, which can involve minimizing or maximizing certain distances or similarities among these vectors.

In particular, in some example implementations, the loss function 250 can be configured as a triplet loss, which can be used to optimize the embedding space by ensuring that embeddings of similar items (e.g., the anchor and positive) are closer together, while embeddings of dissimilar items (e.g., the anchor and negative) are farther apart. This type of loss function evaluates the relative distances between a set of three items: an anchor, a positive example that is similar to the anchor, and a negative example that is dissimilar. The triplet loss function can help in fine-tuning the multi-vector embedding model 210 by adjusting the embeddings based on the computed distances, thereby enhancing the model's ability to discriminate between similar and dissimilar items effectively.

Although FIG. 2 illustrates a triplet loss scheme as one example, the proposed techniques can be equally applied in other embedding model and/or embedding space learning frameworks, including contrastive learning frameworks. Contrastive learning, which focuses on learning embeddings by comparing pairs of similar and dissimilar items, is another method that could benefit from the disclosed clustering and embedding techniques. Additionally, these methods can be adapted for use in other learning frameworks such as “Siamese” networks, which also rely on learning from pairs of items to understand similarities and differences, or other architectures like neural networks that employ quadruplet loss or softmax-based approaches for classification and feature extraction. These frameworks can leverage the described clustering system 220 and multi-vector embedding model 210 to optimize embedding spaces for various types of content and retrieval tasks.

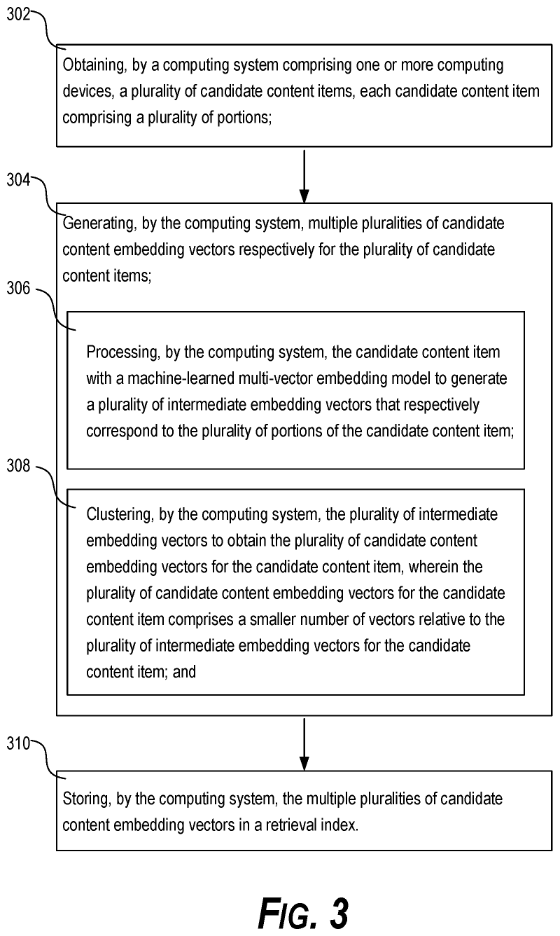

FIG. 3 illustrates a flowchart diagram of an example method for processing and storing multi-vector embeddings related to candidate content items within a retrieval system.

Block 302 includes obtaining, by a computing system comprising one or more computing devices, a plurality of candidate content items, where each candidate content item comprises a plurality of portions. These portions can be segments such as tokens, paragraphs, sentences, or images within a document or other types of content items.

Block 304 includes generating, by the computing system, multiple pluralities of candidate content embedding vectors respectively for the plurality of candidate content items. This process can include several sub-steps detailed in the subsequent blocks. Specifically, in some implementations, block 304 can be performed by performing blocks 306 and 308 respectively for each of the different candidate content items.

Block 306 includes processing, by the computing system, the candidate content item with a machine-learned multi-vector embedding model to generate a plurality of intermediate embedding vectors that respectively correspond to the plurality of portions of the candidate content item. Each intermediate embedding vector can represent a numerical representation of each portion, capturing its core features for further processing.

Block 308 includes clustering, by the computing system, the plurality of intermediate embedding vectors to obtain the plurality of candidate content embedding vectors for the candidate content item. Here, the plurality of candidate content embedding vectors for the candidate content item comprises a smaller number of vectors relative to the plurality of intermediate embedding vectors for the candidate content item, effectively reducing the data dimensionality and focusing on the most relevant features.

Block 310 includes storing, by the computing system, the multiple pluralities of candidate content embedding vectors in a retrieval index. This retrieval index can be utilized for efficiently storing and accessing the processed embeddings for various retrieval tasks, such as searching or document classification.

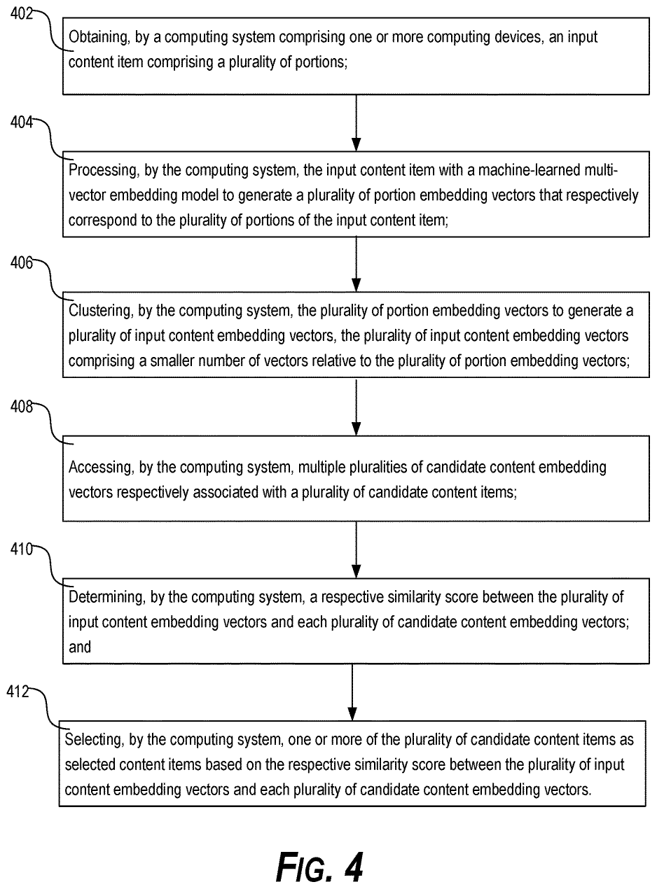

FIG. 4 presents a flowchart diagram of an example method for processing an input content item and retrieving relevant candidate content items based on similarity scoring within a computing system.

Block 402 includes obtaining, by a computing system comprising one or more computing devices, an input content item comprising a plurality of portions. These portions can include various segments such as tokens, sentences, paragraphs, or image sections of the input content item, depending on the nature of the content.

Block 404 includes processing, by the computing system, the input content item with a machine-learned multi-vector embedding model to generate a plurality of portion embedding vectors that respectively correspond to the plurality of portions of the input content item. Each portion embedding vector represents a numerical representation derived from the respective content portion, capturing core features for similarity assessment.

Block 406 includes clustering, by the computing system, the plurality of portion embedding vectors to generate a plurality of input content embedding vectors. The plurality of input content embedding vectors comprises a smaller number of vectors relative to the plurality of portion embedding vectors, effectively condensing the information into more manageable and relevant clusters of data.

Block 408 includes accessing, by the computing system, multiple pluralities of candidate content embedding vectors respectively associated with a plurality of candidate content items. These vectors are typically stored in a retrieval system and represent previously processed candidate content items that are potential matches for the input content item.

Block 410 includes determining, by the computing system, a respective similarity score between the plurality of input content embedding vectors and each plurality of candidate content embedding vectors. This step can include calculating how closely the content represented by the input content embedding vectors matches the content represented by each of the candidate content embedding vectors.

Block 412 includes selecting, by the computing system, one or more of the plurality of candidate content items as selected content items based on the respective similarity score between the plurality of input content embedding vectors and each plurality of candidate content embedding vectors. The selected content items can be those determined to have a high degree of similarity to the input content item, thereby indicating relevance or relatedness based on the computed scores.

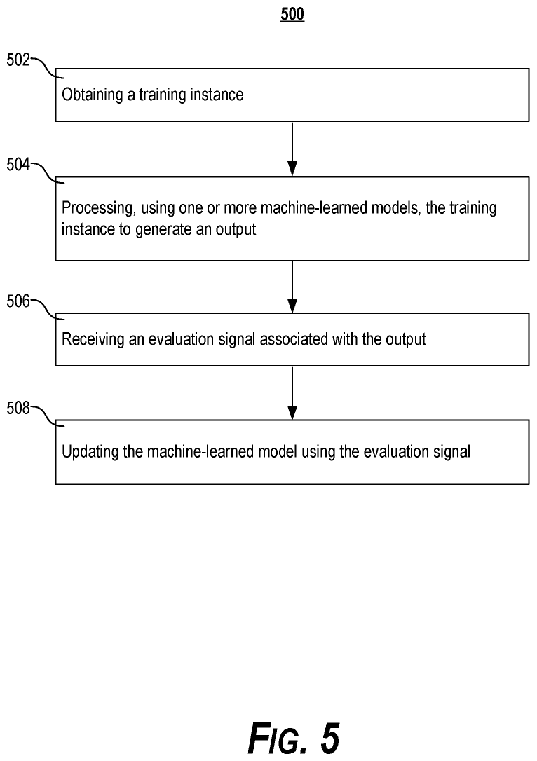

FIG. 5 depicts a flowchart of a method 500 for training one or more machine-learned models according to aspects of the present disclosure. For instance, an example machine-learned model can include a sequence processing model.

One or more portion(s) of example method 500 can be implemented by a computing system that includes one or more computing devices such as, for example, computing systems described with reference to the other figures. Each respective portion of example method 500 can be performed by any (or any combination) of one or more computing devices. Moreover, one or more portion(s) of example method 500 can be implemented on the hardware components of the device(s) described herein, for example, to train one or more systems or models. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 5 is described with reference to elements/terms described with respect to other systems and figures for exemplary illustrated purposes and is not meant to be limiting. One or more portions of example method 500 can be performed additionally, or alternatively, by other systems.

At 502, example method 500 can include obtaining a training instance. A set of training data can include a plurality of training instances divided between multiple datasets (e.g., a training dataset, a validation dataset, or testing dataset). A training instance can be labeled or unlabeled. Although referred to in example method 500 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 504, example method 500 can include processing, using one or more machine-learned models, the training instance to generate an output. The output can be directly obtained from the one or more machine-learned models or can be a downstream result of a chain of processing operations that includes an output of the one or more machine-learned models.

At 506, example method 500 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 508, example method 500 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 500 can include implementing a number of generalization techniques (e.g., weight decays, dropouts, etc.) to improve the generalization capability of the models being trained.

In some implementations, example method 500 can be implemented for training a machine-learned model from an initialized state to a fully trained state (e.g., when the model exhibits a desired performance profile, such as based on accuracy, precision, recall, etc.).

In some implementations, example method 500 can be implemented for particular stages of a training procedure. For instance, in some implementations, example method 500 can be implemented for pre-training a machine-learned model. Pre-training can include, for instance, large-scale training over potentially noisy data to achieve a broad base of performance levels across a variety of tasks/data types.

In some implementations, example method 500 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 500 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 500 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

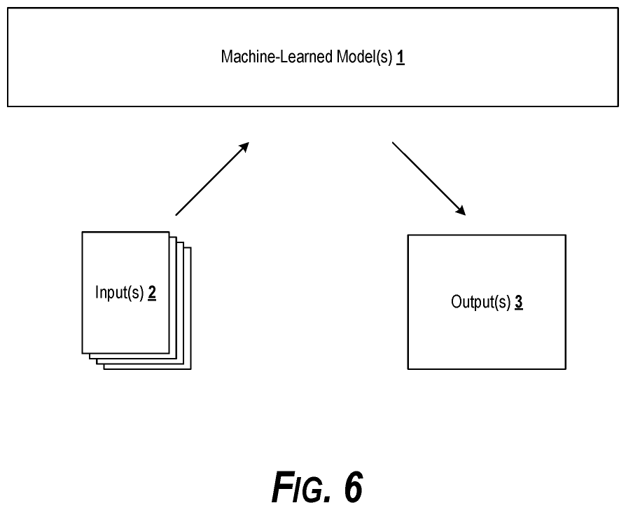

FIG. 6 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of any other machine-learned component described herein, etc. Although various features, variations, and implementations described below are described with respect to machine-learned model(s) 1, it is to be understood that such features, variations, and implementations are to be understood as described with respect to each of any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

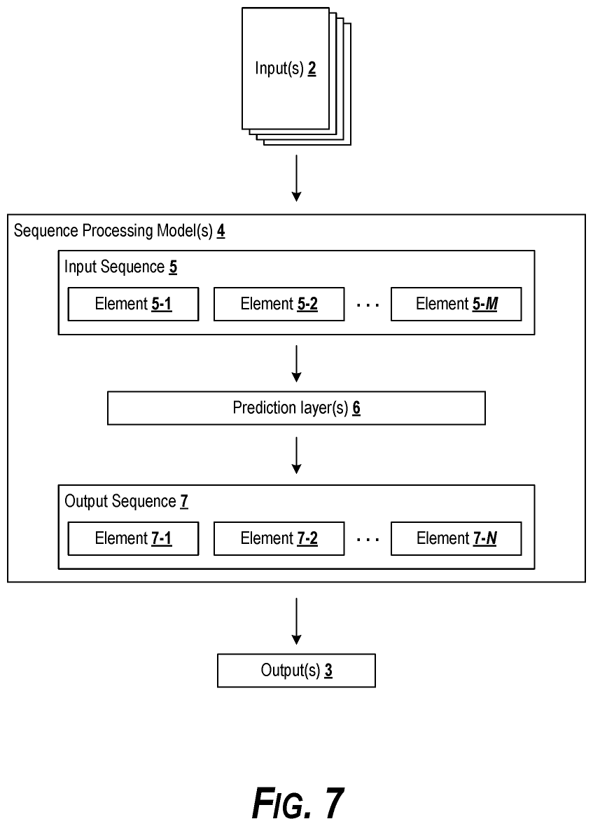

FIG. 7 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 7 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

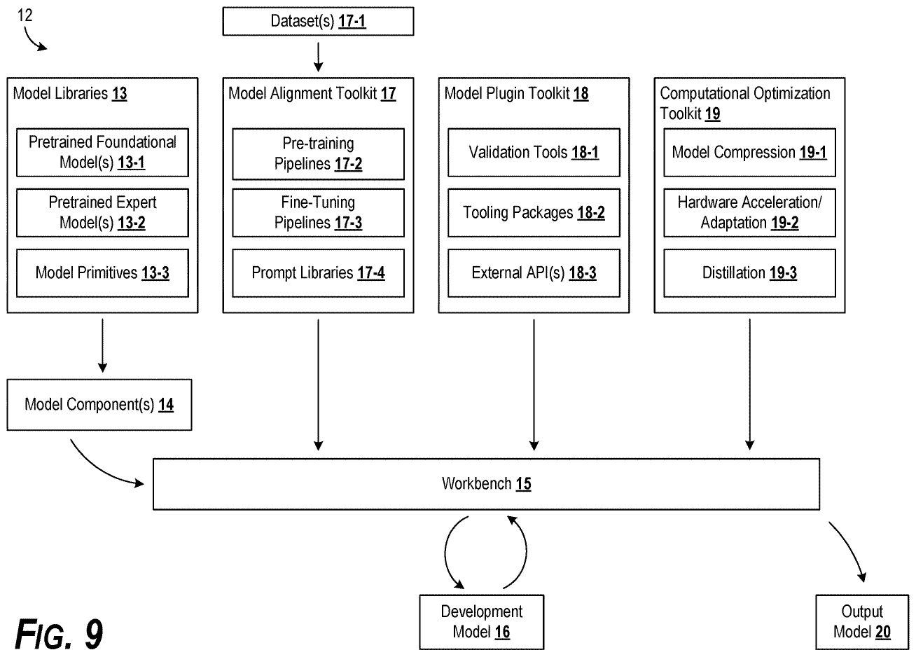

FIG. 8 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

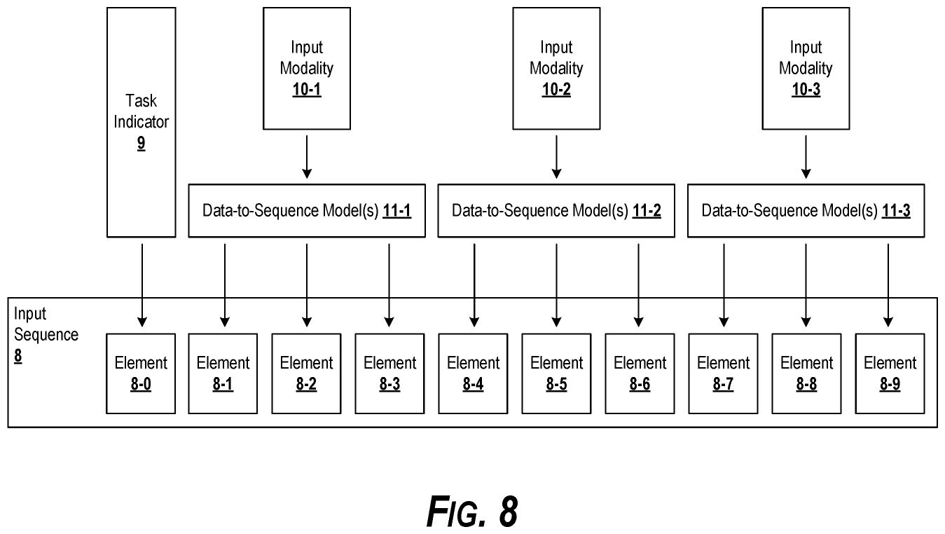

FIG. 9 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., denoising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 500 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

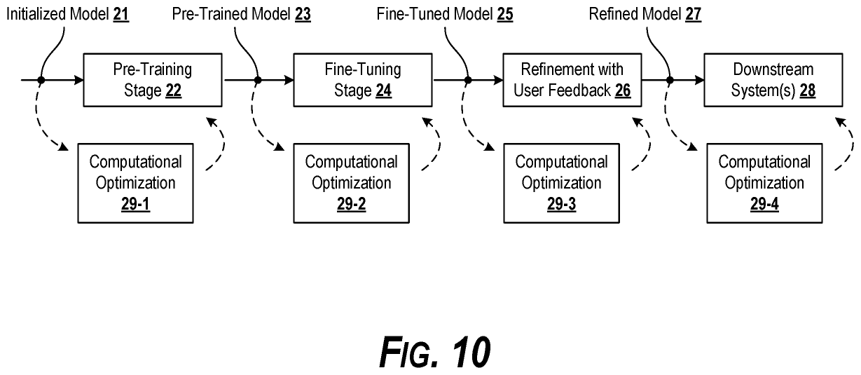

FIG. 10 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

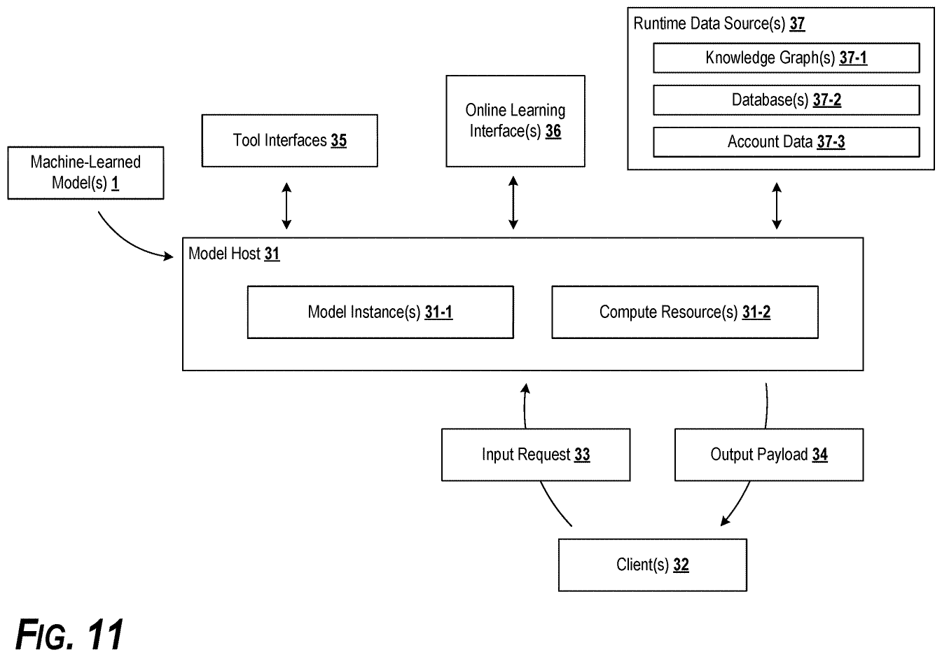

FIG. 11 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

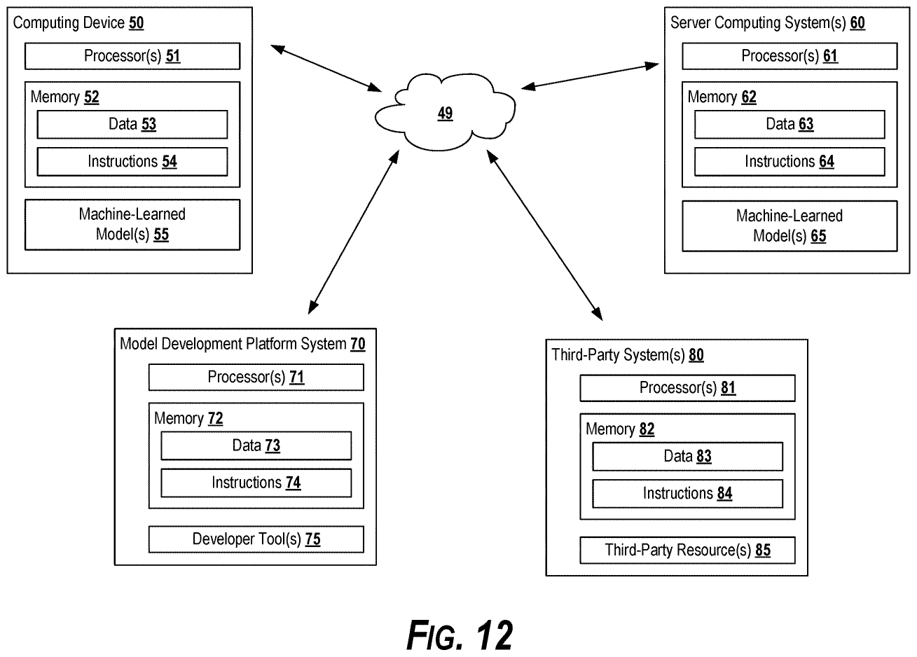

FIG. 12 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 12 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 12 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

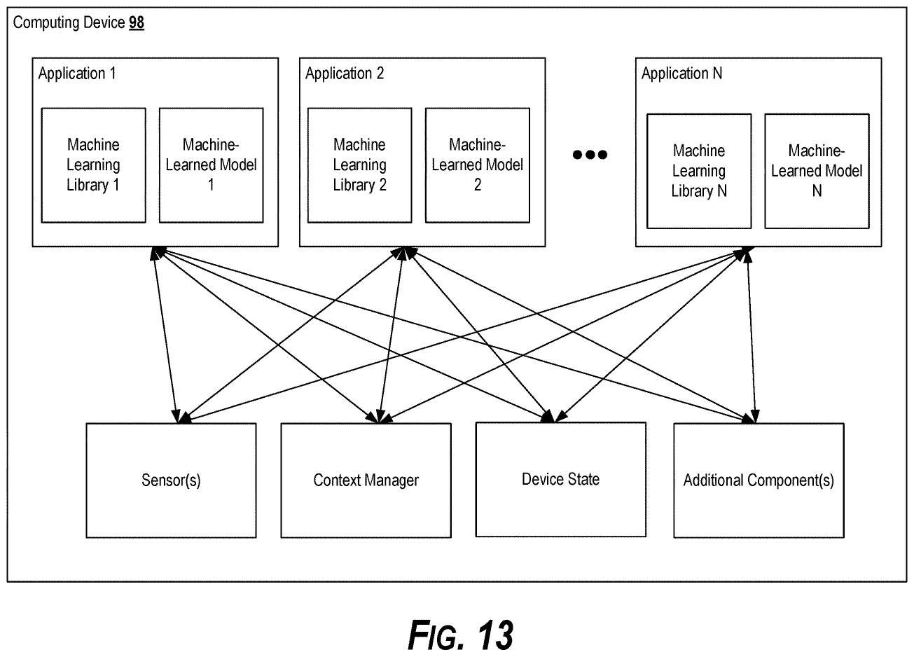

FIG. 13 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 13, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

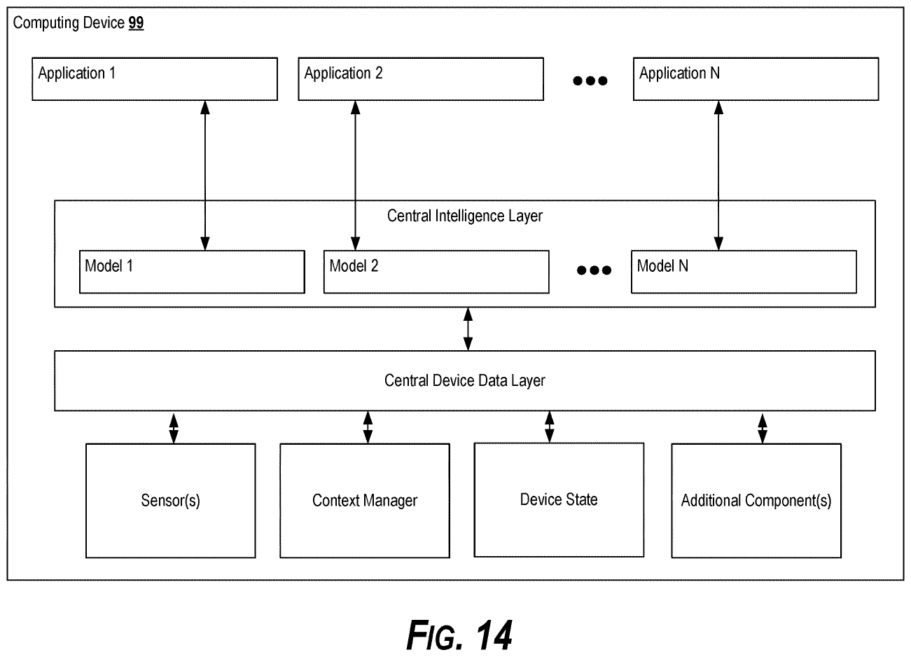

FIG. 14 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 14, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 14, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method for information retrieval with improved computational efficiency, the method comprising:
obtaining, by a computing system comprising one or more computing devices, an input content item comprising a plurality of portions;
processing, by the computing system, the input content item with a machine-learned multi-vector embedding model to generate a plurality of portion embedding vectors that respectively correspond to the plurality of portions of the input content item;
clustering, by the computing system, the plurality of portion embedding vectors to generate a plurality of input content embedding vectors, the plurality of input content embedding vectors comprising a smaller number of vectors relative to the plurality of portion embedding vectors;
accessing, by the computing system, multiple pluralities of candidate content embedding vectors respectively associated with a plurality of candidate content items;
determining, by the computing system, a respective similarity score between the plurality of input content embedding vectors and each plurality of candidate content embedding vectors; and
selecting, by the computing system, one or more of the plurality of candidate content items as selected content items based on the respective similarity score between the plurality of input content embedding vectors and each plurality of candidate content embedding vectors.

2. The computer-implemented method of claim 1, further comprising:
generating the multiple pluralities of candidate content embedding vectors, wherein generating the plurality of candidate content embedding vectors for each candidate content item comprises:
processing, by the computing system, the candidate content item with the machine-learned multi-vector embedding model or a second, different machine-learned multi-vector embedding model to generate a plurality of intermediate embedding vectors; and
clustering, by the computing system, the plurality of intermediate embedding vectors to obtain the plurality of candidate content embedding vectors for the candidate content item,
wherein the plurality of candidate content embedding vectors for the candidate content item comprises a smaller number of vectors relative to the plurality of intermediate embedding vectors for the candidate content item.

3. The computer-implemented method of claim 1, wherein clustering, by the computing system, the plurality of portion embedding vectors to generate the plurality of input content embedding vectors comprises:
clustering, by the computing system, the plurality of portion embedding vectors to form a plurality of clusters; and
respectively pooling, by the computing system, the portion embedding vectors contained in each cluster to generate the plurality of input content embedding vectors.

4. The computer-implemented method of claim 1, wherein clustering, by the computing system, the plurality of portion embedding vectors comprises performing, by the computing system, K-means clustering on the plurality of portion embedding vectors to generate a number K of input content embedding vectors.

5. The computer-implemented method of claim 4, wherein the number K is adaptive to and a function of a length of the input content item.

6. The computer-implemented method of claim 1, wherein clustering, by the computing system, the plurality of portion embedding vectors comprises performing, by the computing system, a hierarchical clustering algorithm on the input content item to generate a hierarchically-structured set of input content embedding vectors.

7. The computer-implemented method of claim 1, wherein determining, by the computing system, the respective similarity score between the plurality of input content embedding vectors and each plurality of candidate content embedding vectors comprises determining, by the computing system, a respective Chamfer distance between the plurality of input content embedding vectors and each plurality of candidate content embedding vectors.

8. The computer-implemented method of claim 1, wherein determining, by the computing system, the respective similarity score between the plurality of input content embedding vectors and each plurality of candidate content embedding vectors comprises respectively processing, by the computing system, each unique combination of the plurality of input content embedding vectors and the multiple pluralities of candidate content embedding vectors with one or more linear or non-linear layers to generate the respective similarity score for such unique combination.

9. The computer-implemented method of claim 1, wherein the input content item comprises at least a portion of a model input to a machine learning model and the plurality of candidate content items comprise content items associated with a retrieval augmented generation system.

10. The computer-implemented method of claim 9, further comprising:
generating, by the computing system, an updated model input that includes the selected content items; and
processing, by the computing system, the updated model input with the machine learning model to generate a model output.

11. The computer-implemented method of claim 1, further comprising training, by the computing system, the machine-learned multi-vector embedding model based at least in part on the input content embedding vectors.

12. A computing system for information retrieval with improved computational efficiency, the computing system comprising one or more processors and one or more non-transitory computer-readable media that collectively store instructions that, when executed by the one or more processors, cause the computing system to perform operations, the operations comprising:
obtaining, by the computing system, a plurality of candidate content items, each candidate content item comprising a plurality of portions;
generating, by the computing system, multiple pluralities of candidate content embedding vectors respectively for the plurality of candidate content items, wherein generating the plurality of candidate content embedding vectors for each candidate content item comprises:
processing, by the computing system, the candidate content item with a machine-learned multi-vector embedding model to generate a plurality of intermediate embedding vectors that respectively correspond to the plurality of portions of the candidate content item; and
clustering, by the computing system, the plurality of intermediate embedding vectors to obtain the plurality of candidate content embedding vectors for the candidate content item, wherein the plurality of candidate content embedding vectors for the candidate content item comprises a smaller number of vectors relative to the plurality of intermediate embedding vectors for the candidate content item; and
storing, by the computing system, the multiple pluralities of candidate content embedding vectors in a retrieval index.

13. The computing system of claim 12, wherein the operations further comprise:
obtaining, by a computing system comprising one or more computing devices, an input content item;
processing, by the computing system, the input content item with the machine-learned multi-vector embedding model or a second, different machine-learned multi-vector embedding model to generate a plurality of input content embedding vectors;
determining, by the computing system, a respective similarity score between the plurality of input content embedding vectors and each plurality of candidate content embedding vectors; and
selecting, by the computing system, one or more of the plurality of candidate content items as selected content items based on the respective similarity score between the plurality of input content embedding vectors and each plurality of candidate content embedding vectors.

14. The computing system of claim 13, wherein determining, by the computing system, the respective similarity score between the plurality of input content embedding vectors and each plurality of candidate content embedding vectors comprises determining, by the computing system, a respective Chamfer distance between the plurality of input content embedding vectors and each plurality of candidate content embedding vectors.

15. The computing system of claim 13, wherein determining, by the computing system, the respective similarity score between the plurality of input content embedding vectors and each plurality of candidate content embedding vectors comprises respectively processing, by the computing system, each unique combination of the plurality of input content embedding vectors and the multiple pluralities of candidate content embedding vectors with one or more linear or non-linear layers to generate the respective similarity score for such unique combination.

16. The computing system of claim 12, wherein clustering, by the computing system, the plurality of intermediate embedding vectors to generate the plurality of candidate content embedding vectors comprises:
clustering, by the computing system, the plurality of intermediate embedding vectors to form a plurality of clusters; and
respectively pooling, by the computing system, the intermediate embedding vectors contained in each cluster to generate the plurality of candidate content embedding vectors.

17. The computing system of claim 12, wherein clustering, by the computing system, the plurality of intermediate embedding vectors comprises performing, by the computing system, K-means clustering on the plurality of intermediate embedding vectors to generate a number K of candidate content embedding vectors.

18. The computing system of claim 12, wherein clustering, by the computing system, the plurality of intermediate embedding vectors comprises performing, by the computing system, a hierarchical clustering algorithm on each candidate content item to generate a hierarchically-structured set of candidate content embedding vectors.

19. The computing system of claim 12, wherein the input content item comprises a search query and the plurality of candidate content items comprise a plurality of indexed web documents.

20. The computing system of claim 12, wherein the input content item comprises at least a portion of a model input to a machine learning model and the plurality of candidate content items comprise content items associated with a retrieval augmented generation syst
